(19) United States
(12) Patent Application Publication
(10) Pub. No.: US 2026/0122116 A1
(43) Pub. Date: Apr. 30, 2026

(54) METHOD, APPARATUS, PRODUCT AND PRODUCT FOR GENERATING IDENTIFIER, IDENTIFYING AND OBTAINING EFFECT

(71) Applicant: Beijing Zitiao Network Technology Co., Ltd., Beijing (CN)

(72) Inventors: Chang YIN, Beijing (CN); Luxiaohan HE, Los Angeles, CA (US); Chaoyi CHENG, Beijing (CN); Haoming TAN, Beijing (CN); Jianhua XU, Beijing (CN); Ju HE, Beijing (CN); Zhenyu YUE, Beijing (CN); Long CHEN, Beijing (CN); Xin YU, Beijing (CN); Wei JIANG, Beijing (CN); Wei ZHANG, Beijing (CN)

(21) Appl. No.: 19/374,992

(22) Filed: Oct. 30, 2025

(30) Foreign Application Priority Data
Oct. 30, 2024 (CN) 202411537662.2

(51) Int. Cl. H04L 65/1089; G06F 16/11; G06F 21/62

(52) U.S. Cl. CPC H04L 65/1089; G06F 16/116; G06F 21/6218

(57) ABSTRACT

The present disclosure relates to methods, apparatuses, devices and products for generating an identifier, identifying and obtaining an effect. A method is performed by a first client. The method includes generating first user-generated content (UGC) data from shooting by a first user based on an effect. The method further includes sending the first UGC data to a server. The method further includes receiving a first UGC identifier corresponding to the first UGC data from the server, where the first UGC identifier is used to identify the first UGC data generated from the shooting based on the effect.

### CROSS-REFERENCE TO RELATED APPLICATION(S)

This application claims priority to Chinese Application No. 202411537662.2 filed Oct. 30, 2024, the disclosure of which is incorporated herein by reference in its entirety.

### FIELD

The present disclosure relates to the field of computers, and more specifically to methods, apparatuses, devices and products for generating an identifier, identifying and obtaining an effect.

### BACKGROUND

Currently, the effect field is undergoing innovation and development, with effect customization technologies being widely applied. The effect customization technologies allow users to freely unleash creativity by uploading their materials, such as pictures and videos, and utilizing system-provided tools to transform these materials into unique effects. Each newly generated effect has an independent resource package, and the users may make further adjustment and optimization to these effects according to their needs.

A real-time social multi-play method further expands game and social experience of the users based on the effect customization technologies. The real-time social multi-game method combines an ecosystem of a game effects artist with desktop infrastructures. A game effects artist can leverage professional expertise and tools thereof to create various interesting and creative effects. In addition, through real-time communication technologies, the users can achieve seamless connection with other players, enjoying smooth multi-player or two-player interactive gaming experience.

### SUMMARY

In a first aspect of the embodiments of the present disclosure, a method for identifying an effect is provided. The method is performed by a first client. The method includes generating first user-generated content (UGC) data from shooting by a first user based on an effect. The method further includes sending the first UGC data to a server. In addition, the method further includes receiving a first UGC identifier corresponding to the first UGC data from the server, where the first UGC identifier is used to identify the first UGC data generated from the shooting based on the effect.

In a second aspect of the embodiments of the present disclosure, a method for generating an identifier of an effect is provided. The method is performed by a server. The method includes receiving, from a first client, first UGC data after a first user uses an effect. The method further includes generating a first UGC identifier corresponding to the first UGC data based on the first UGC data, where the first UGC identifier is used to identify the first UGC data generated from the shooting based on the effect. In addition, the method further includes sending the first UGC identifier to the first client.

In a third aspect of the embodiments of the present disclosure, a method for obtaining an effect is provided. The method is performed by a second client. The method includes sending a first UGC identifier corresponding to first UGC data to a server, where the first UGC data is from shooting by a user on a first client based on an effect. The method further includes receiving the first UGC data from the server. In addition, the method further includes rendering the effect of the first UGC data based on the first UGC data, where a second user obtains second UGC data on the second client by shooting based on the effect, and the second user performs effect interaction on the second client based on the first UGC data and the second UGC data.

In a fourth aspect of the embodiments of the present disclosure, an apparatus for identifying an effect is provided. The apparatus is deployed on a first client. The apparatus includes a UGC data generation module configured to generate first user-generated content UGC data from shooting by a first user based on an effect. The apparatus further includes a UGC data sending module configured to send the first UGC data to a server. In addition, the apparatus further includes a UGC identifier receiving module configured to receive a first UGC identifier corresponding to the first UGC data from the server, where the first UGC identifier is used to identify the first UGC data generated from the shooting based on the effect.

In a fifth aspect of the embodiments of the present disclosure, an apparatus for generating an identifier of an effect is provided. The apparatus is deployed on a server. The apparatus includes a UGC data receiving module configured to receive, from a first client, first user-generated content UGC data generated in response to a first user using an effect. The apparatus further includes a UGC identifier generation module configured to generate a first UGC identifier corresponding to the first UGC data based on the first UGC data, where the first UGC identifier is used to identify the first UGC data generated from the shooting based on the effect. In addition, the apparatus further includes a UGC identifier sending module configured to send the first UGC identifier to the first client.

In a sixth aspect of the embodiments of the present disclosure, an apparatus for obtaining an effect is provided. The apparatus is deployed on a second client. The apparatus includes a UGC identifier sending module configured to send a first UGC identifier corresponding to UGC data to a server, where the first UGC data is from shooting by a first user on a first client based on an effect. The apparatus further includes a UGC data receiving module configured to receive the first UGC data from the server. In addition, the apparatus further includes an effect rendering module configured to render the effect of the first UGC data based on the first UGC data, where a second user obtains second UGC data on the second client by shooting based on the effect, and the second user performs effect interaction on the second client based on the first UGC data and the second UGC data.

According to a seventh aspect of the embodiments of the present disclosure, an electronic device is provided. The electronic device includes one or more processors; and a storage apparatus configured to store one or more programs, where the one or more programs, when executed by the one or more processors, cause the one or more processors to implement a method for identifying an effect. The method includes generating first user-generated content UGC data from shooting by a first user based on an effect. The method further includes sending the first UGC data to a server. In addition, the method further includes receiving a first UGC identifier corresponding to the first UGC data from the server, where the first UGC identifier is used to identify the first UGC data generated from the shooting based on the effect.

According to an eighth aspect of the embodiments of the present disclosure, an electronic device is provided. The electronic device includes one or more processors; and a storage apparatus configured to store one or more programs, where the one or more programs, when executed by the one or more processors, cause the one or more processors to implement a method for generating an identifier of an effect. The method includes receiving, from a first client, first UGC data generated in response to a first user using an effect. The method further includes generating a first UGC identifier corresponding to the first UGC data based on the first UGC data, where the first UGC identifier is used to identify the first UGC data generated from the shooting based on the effect. In addition, the method further includes sending the first UGC identifier to the first client.

According to a ninth aspect of the embodiments of the present disclosure, an electronic device is provided. The electronic device includes one or more processors; and a storage apparatus configured to store one or more programs, where the one or more programs, when executed by the one or more processors, cause the one or more processors to implement a method for obtaining an effect. The method includes sending a first UGC identifier corresponding to first UGC data to a server, where the first UGC data is from shooting by a first user on a first client based on an effect. The method further includes receiving the first UGC data from the server. In addition, the method further includes rendering the effect of the first UGC data based on the first UGC data, where a second user obtains second UGC data on a second client by shooting based on the effect, and the second user performs effect interaction on the second client based on the first UGC data and the second UGC data.

According to a tenth aspect of the embodiments of the present disclosure, a computer program product is provided. The computer program product is tangibly stored on a non-transitory computer-readable medium and includes machine-executable instructions that, when executed, cause a machine to implement a method for identifying an effect. The method includes generating first UGC data from shooting by a first user based on an effect. The method further includes sending the first UGC data to a server. In addition, the method further includes receiving a first UGC identifier corresponding to the first UGC data from the server, where the first UGC identifier is used to identify the first UGC data generated from the shooting based on the effect.

According to an eleventh aspect of the embodiments of the present disclosure, a computer program product is provided. The computer program product is tangibly stored on a non-transitory computer-readable medium and includes machine-executable instructions that, when executed, cause a machine to implement a method for generating an identifier of an effect. The method includes receiving, from a first client, first UGC data generated in response to a first user using an effect. The method further includes generating a first UGC identifier corresponding to the first UGC data based on the first UGC data, where the first UGC identifier is used to identify the first UGC data generated from the shooting based on the effect. In addition, the method further includes sending the first UGC identifier to the first client.

According to a twelfth aspect of the embodiments of the present disclosure, a computer program product is provided. The computer program product is tangibly stored on a non-transitory computer-readable medium and includes machine-executable instructions that, when executed, cause a machine to implement a method for obtaining an effect. The method includes sending a first UGC identifier corresponding to first UGC data to a server, where the first UGC data is from shooting by a first user on a first client based on an effect. The method further includes receiving the first UGC data from the server. In addition, the method further includes rendering the effect of the first UGC data based on the first UGC data, where a second user obtains second UGC data on a second client by shooting based on the effect, and the second user performs effect interaction on the second client based on the first UGC data and the second UGC data.

The section Summary is provided to introduce a selection of concepts in a simplified form, which will be further described in the detailed description below. The section Summary is neither intended to identify key features or principal features of the claimed subject matter, nor to limit the scope of the claimed subject matter.

### BRIEF DESCRIPTION OF THE DRAWINGS

The foregoing and other features, advantages and aspects of embodiments of the present disclosure become more apparent with reference to the following detailed description and in conjunction with the accompanying drawings. Throughout the accompanying drawings, the same or similar reference numerals denote the same or similar elements, in which:

FIG. 1 is a schematic diagram of an example environment in which a plurality of embodiments of the present disclosure can be implemented;

FIG. 2A is a flowchart of a method for identifying an effect according to some embodiments of the present disclosure;

FIG. 2B is a flowchart of a method for generating an identifier of an effect according to some embodiments of the present disclosure;

FIG. 2C is a flowchart of a method for obtaining an effect according to some embodiments of the present disclosure;

FIG. 3 is a timing diagram of generating a UGC identifier according to some embodiments of the present disclosure;

FIG. 4 is a timing diagram of performing collaborative shooting (or duet) by using a UGC identifier according to some embodiments of the present disclosure;

FIG. 5A is a flowchart of a method for writing UGC data to a temporary resource folder by an effect side according to some embodiments of the present disclosure;

FIG. 5B is a schematic diagram of writing UGC data to a temporary resource folder according to some embodiments of the present disclosure;

FIG. 6A is a flowchart of a method for obtaining UGC data according to some embodiments of the present disclosure;

FIG. 6B is a schematic diagram of receiving UGC data according to some embodiments of the present disclosure;

FIG. 7 is a flowchart of a method for obtaining a UGC identifier on a client and writing the UGC identifier to a message according to some embodiments of the present disclosure;

FIG. 8 is a flowchart of a method for rendering an effect and a user avatar on a client based on a UGC identifier according to some embodiments of the present disclosure;

FIG. 9 is a schematic diagram of an overall link for generating a UGC identifier and rendering an effect based on the UGC identifier according to some embodiments of the present disclosure;

FIG. 10 is a schematic diagram of an overall link for delivering a UGC identifier and UGC data by a server according to some embodiments of the present disclosure;

FIG. 11 is an effect diagram of implementing a method for obtaining an effect according to some embodiments of the present disclosure;

FIG. 12A is a block diagram of an apparatus for identifying an effect according to some embodiments of the present disclosure;

FIG. 12B is a block diagram of an apparatus for generating an identifier of an effect according to some embodiments of the present disclosure;

FIG. 12C is a block diagram of an apparatus for obtaining an effect according to some embodiments of the present disclosure; and

FIG. 13 is a block diagram of a device capable of implementing a plurality of embodiments of the present disclosure.

### DETAILED DESCRIPTION OF EMBODIMENTS

It may be understood that all user-related data involved in the technical solutions should be obtained and used with the authorization of the user. It means that in the technical solutions, if personal information of the user needs to be used, explicit consent and authorization of the user are required before the data is obtained, otherwise the collection and use of the related data will be disallowed. It should also be understood that during implementation of the technical solutions, the collection, use, and storage of data should strictly comply with relevant laws and regulations, necessary technologies and measures should be used to ensure the security of the user data and ensure safe use of the data.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, upon reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

In an alternative but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

In the description of the embodiments of the present disclosure, the term “include” and similar terms should be understood as open-ended inclusion, namely, “including but not limited to”. The term “based on” should be understood as “at least partially based on”. The term “an embodiment” or “the embodiment” should be understood as “at least one embodiment”. The terms “first”, “second”, and the like may refer to different objects or the same object, unless otherwise explicitly defined. Other explicit and implicit definitions may be included below.

As mentioned above, effect customization technologies can bring creativity to users, but the effect customization technologies also have some defects. Since each customized effect may undergo fission to generate a plurality of sub-effects, a large number of effect resource packages are generated, resulting in an increase in a system load and making aggregation of user play data extremely difficult. For example, in the case that there are a plurality of different effects, each effect has a plurality of versions and variants, resulting in extremely high costs and resource consumption during management of these effects and resource packages.

In addition, a real-time social multi-play method brings good game and social experience, but leads to relatively high implementation costs. This is mainly reflected in technical development and maintenance. To ensure the smoothness and the stability of real-time communication, it is necessary to invest substantial resources to optimize a network architecture and server performance.

To this end, the present disclosure provides a method for generating an identifier, a method for identifying an effect, and a method for obtaining an effect. First, a user obtains UGC data and sends the UGC data to a server when shooting based on an effect on a client. The server generates, based on the UGC data, a UGC identifier used to identify the UGC data, and sends the UGC identifier to the client. After the UGC data is identified, another client can obtain the UGC data by sending the UGC identifier to the server, to render the effect of the UGC data. In this way, intelligent management of effect data is achieved, the system load is reduced, and aggregation of the UGC data is also achieved, thereby improving the diversity of aggregation and fission manners of user gameplay data, improving effect utilization, and further enriching user gaming experience.

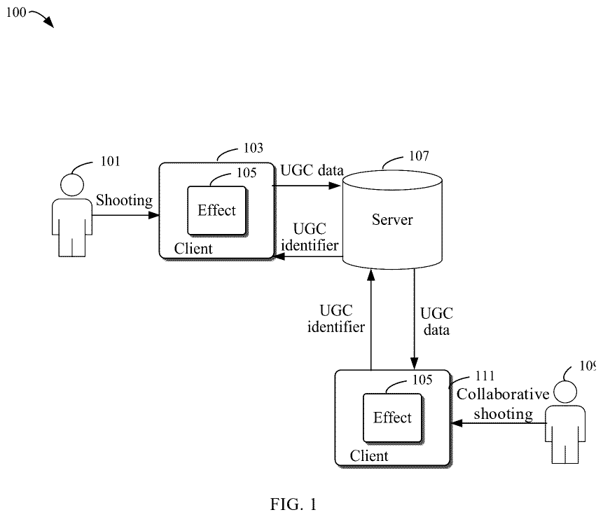

FIG. 1 is a schematic diagram of an example environment 100 in which a plurality of embodiments of the present disclosure can be implemented. As shown in FIG. 1, the example environment 100 may include a client 103 (also referred to as a first client). The client 103 can display an effect 105 through various devices, for example, a smartphone, a tablet computer, and a television. The effect 105 may be pre-stored locally on the client 103 or may be downloaded from a server 107. The client 103 can perform processing such as decoding and rendering on the effect, and finally visually present the effect 105 to a user 101 (also referred to as a first user). It should be understood that the effect 105 is used to change or enhance media such as a video and an image, to provide the user with a new shooting experience, making a shot work more unique. In this embodiment of the present disclosure, the effect 105 may be a simple filter or may be a complex animation effect. This is not limited in the present disclosure. When the user 101 performs the shooting based on the effect 105, the client 103 displays the effect 105 and applies the effect to a video or an image the user is shooting. For example, if the user 101 selects a “face-changing” effect, the face of the user 101 is replaced with a preset face image in real time during shooting.

In some embodiments, the client 103 may obtain UGC data generated by the user 101. The UGC data is data that is generated and recorded by the user 101 using the effect 105 on the client 103 and that indicates an operation, behavior, or output of the user, and the UGC data may include an object, a trajectory, texture information, text information, spatial information, and the like of a picture. For example, when the face-changing effect is used, the UGC data is the user's facial video or facial image that is processed with the effect 105. For another example, when the user 101 uses the effect 105 for drawing, the UGC data may be handwriting data of the user 101.

As shown in FIG. 1, after obtaining the UGC data, the client 103 sends the UGC data to the server 107, and the server 107 generates a UGC identifier based on the received UGC data. The UGC identifier is used to uniquely identify and distinguish each piece of UGC data. In some embodiments, the server 107 may associate the generated UGC identifier with corresponding UGC data and store them in a database system. In this way, whenever particular UGC data needs to be found or accessed, the UGC data can be quickly addressed by using a UGC identifier thereof. After generating the UGC identifier, the server 107 sends the UGC identifier to the client 103. In this way, in the client 103, the UGC identifier is associated with the UGC data. When the user 101 wants to share or upload a video or a picture generated from the shooting based on the effect 105, the UGC identifier is sent along with the effect-based work as a full-scenario circulation field.

In some embodiments, when the effect-based work of the user 101 is shared with or distributed to a different user 109 (also referred to as a second user) on a client 111 (also referred to as a second client), a collaborative shooting effect (or duet effect) is found and triggered by using a link displayed on the client 111, such as an effect anchor, a share panel, a collaborative effect, a friend message, a music details page, or plus-sign alienation and etc. Because the UGC identifier is sent or distributed along with the effect-based work, when the user 109 initiates a collaborative shooting, the client 111 extracts the UGC identifier from the effect-based work and sends the UGC identifier to the server 107. After receiving the UGC identifier, the server 107 retrieves the UGC data corresponding to the UGC identifier in the database system. After the corresponding UGC data is found, the server 107 sends the UGC data back to the client 111. After receiving the data, the client 111 may render the UGC data onto a screen to implement collaborative shooting and aggregation of effect data of the user 101 and the user 109.

For example, when the user 101 and the user 109 use a same face-changing effect, two images may be displayed on the screen of the client 111, the upper image being the face-changing effect-based work of the user 101 as a reference, and the lower image being a real-time camera image of the user 109. This camera image changes with a facial movement of the user 109 in real time, and uses the same face-changing effect as the user 101. The user 109 can adjust his/her expression and movements while watching the reference image above to achieve better results during collaborative shooting. When the user 109 completes shooting, the client 111 sends new UGC data, that is, the face-changing effect-based work of the user 109, to the server 107 to generate a new UGC identifier.

In this way, intelligent management of effect data is achieved, the system load is reduced, and aggregation of the UGC data is also achieved, thereby improving the diversity of aggregation and fission manners of user gameplay data, improving effect utilization, and further enriching user gaming experience.

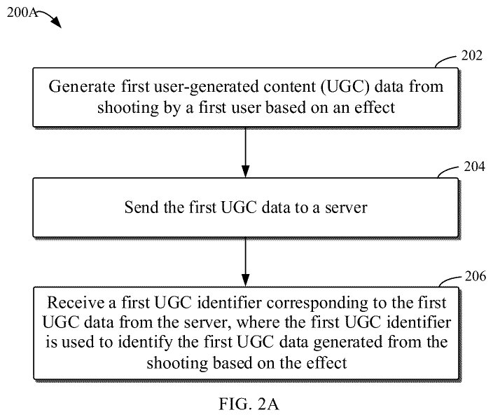

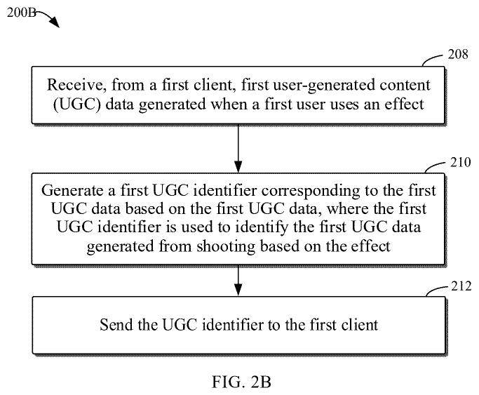

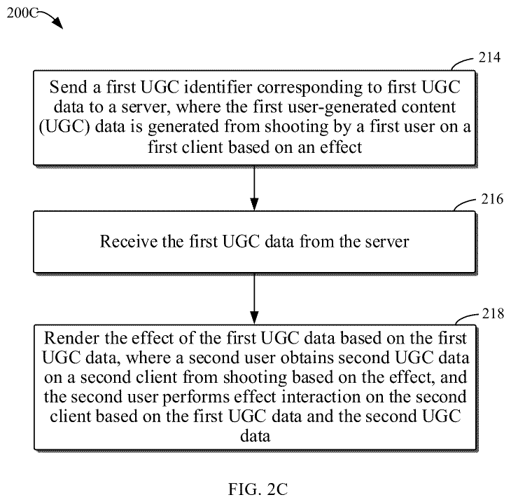

FIG. 2A is a flowchart of a method 200A for identifying an effect according to some embodiments of the present disclosure. The method 200A may be performed by a first client. The method 200A includes block 202, block 204, and block 206.

As shown in FIG. 2A, at block 202, first UGC data from shooting by a first user based on an effect is generated. Referring to FIG. 1, the client 103 (also referred to as the first client) may obtain the UGC data (also referred to as the first UGC data) that is generated and recorded when the user 101 uses the effect 105 on the client 103 and used to indicate the user's operation, behavior, or output. For example, when the face-changing effect is used, the UGC data is the user's facial video or facial image processed with the effect 105. For another example, when the user 101 uses the effect 105 for drawing, the UGC data may be handwriting data of the user 101. In a process in which the user 101 uses the effect for shooting, the generated UGC data may be written to a temporary resource folder by an effect side of the client 103, to store the UGC data generated in real time in the client 103 locally.

At block 204, the first UGC data is sent to a server. Refer to FIG. 1. After the user 101 completes shooting, that is, obtains all UGC data of the effect-based work, the UGC data may be compressed, and the compressed UGC data is then sent from the client 103 to the server 107. The client 103 obtains an interface created by the server 107 for the UGC data, and uploads the UGC data to the server 107 through the interface.

At block 206, a first UGC identifier corresponding to the first UGC data is received from the server, where the first UGC identifier is used to identify the first UGC data generated from the shooting based on the effect. Refer to FIG. 1. After receiving the UGC data, the server 107 generates a UGC identifier (also referred to as the first UGC identifier) that uniquely identifies and distinguishes each piece of UGC data. After the UGC identifier is generated, the client 103 receives the UGC identifier from the server 107. In this way, in the client 103, the UGC identifier is associated with the UGC data. When the user 101 wants to share or upload a video or picture from the shooting based on the effect 105, the UGC identifier is sent along with the effect-based work.

FIG. 2B is a flowchart of a method 200B for generating an identifier of an effect according to some embodiments of the present disclosure. The method 200B may be performed by a server. The method 200B includes block 208, block 210, and block 212.

As shown in FIG. 2B, at block 208, first UGC data generated when a first user uses an effect is received from a first client. Refer to FIG. 1. The client 103 may obtain the UGC data that is generated and recorded when the user 101 uses the effect 105 on the client 103 and that is used to indicate the user's the operation, behavior, or output. After the user 101 completes shooting, that is, obtains all UGC data of the effect-based work, the UGC data may be compressed, and then the server 107 receives the UGC data from the client 103.

At block 210, a first UGC identifier corresponding to the first UGC data is generated based on the first UGC data, where the first UGC identifier is used to identify the first UGC data generated from shooting based on the effect. Refer to FIG. 1. The server 107 generates the UGC identifier based on the received UGC data. The UGC identifier is used to uniquely identify and distinguish each piece of UGC data. In some embodiments, the server 107 may associate the generated UGC identifier with corresponding UGC data and store the same in a database system. In this way, whenever particular UGC data needs to be found or accessed, the UGC data can be quickly addressed by using a UGC identifier thereof.

At block 212, the first UGC identifier is sent to the first client. Refer to FIG. 1. After the server 107 generates the UGC identifier, the UGC identifier is sent from the server 107 to the client 103. In this way, in the client 103, the UGC identifier is associated with the UGC data. When the user 101 wants to share or upload a video or picture from the shooting based on the effect 105, the UGC identifier is sent along with the effect-based work.

FIG. 2C is a flowchart of a method 200C for obtaining an effect according to some embodiments of the present disclosure. The method 200C may be performed by a first client. The method 200C includes block 214, block 216, and block 218.

At block 214, a first UGC identifier corresponding to first UGC data is sent to a server, where the first UGC data is generated from shooting by a first user on a first client based on an effect. Refer to FIG. 1. When the effect-based work of the user 101 is shared with or distributed to the different user 109 on the client 111 (also referred to as the second client), the collaborative shooting effect is found and triggered by using the link displayed on the client 111, such as the effect anchor, the share panel, the collaborative effect, the friend message, the music details page, or the plus-sign alienation. Because the UGC identifier is sent or distributed along with the effect-based work, when the user 109 initiates a collaborative shooting, the client 111 extracts the UGC identifier from the effect-based work and sends the UGC identifier to the server 107.

At block 216, the first UGC data is received from the server. Refer to FIG. 1. After receiving the UGC identifier, the server 107 retrieves the UGC data corresponding to the UGC identifier in the database system. After the corresponding UGC data is found, the server 107 sends the UGC data back to the client 111.

At block 218, the effect of the first UGC data is rendered based on the first UGC data, where a second user obtains second UGC data on a second client from shooting based on the effect, and the second user performs effect interaction on the second client based on the first UGC data and the second UGC data. Refer to FIG. 1. After receiving the data, the client 111 may render the UGC data onto a screen to implement collaborative shooting and aggregation of effect data of the user 101 and the user 109. For example, when the user 101 and the user 109 use a same face-changing effect, two images may be displayed on the screen of the client 111, the upper image being a face-changing effect-based work of the user 101 as a reference, and the lower image being a real-time camera image of the user 109. This camera image changes with a facial movement of the user 109 in real time, and uses the same face-changing effect as the user 101. The user 109 can adjust the user's expression and movement while watching the reference picture above to achieve better results during collaborative shooting, thereby implementing effect interaction between different users. When the user 109 completes shooting, the client 111 sends new UGC data, that is, the face-changing effect-based work of the user 109, to the server 107 to generate a new UGC identifier.

In this way, intelligent management of effect data is achieved, the system load is reduced, and aggregation of the UGC data is also achieved, thereby improving the diversity of aggregation and fission manners of user gameplay data, improving effect utilization, and further enriching user gaming experience.

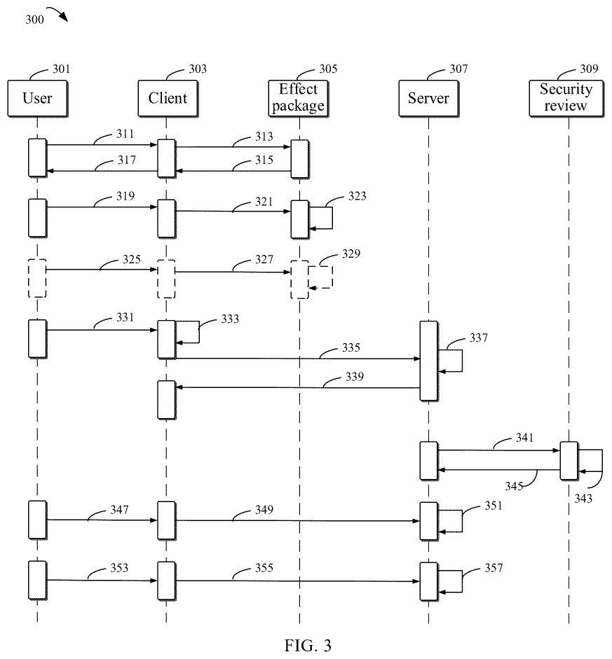

FIG. 3 is a timing diagram of generating a UGC identifier according to some embodiments of the present disclosure. Refer to FIG. 1. A process of generating the UGC identifier includes a communication process between the user 101, the client 103, and the server 107. Therefore, a user 301 in FIG. 3 is consistent with the user 101 in FIG. 1, a client 303 is consistent with the client 103, and a server 307 is consistent with the server 107. FIG. 3 further includes an effect package 305 and a security moderation platform 309. The effect package 305 is configured to perform processing such as decoding and rendering and the like on an effect on the client 303, to display the effect on the device of the client 303, and the security moderation platform 309 is configured to moderate the generated UGC data, and filter out information such as sensitive text and picture and the like. Specific steps for generating a UGC identifier and sending the UGC identifier with UGC data are described below.

At 311, when the user 301 wants to shoot using an effect, an instruction for applying an effect may be sent to the client 303 by using a control or link displayed on the client 303. At 313, the client 303 sends an effect rendering message to the effect package 305 after receiving the instruction for applying the effect. At 315, the effect package 305 displays the effect on a display screen or interface of the client 303 after receiving the effect rendering message, and applies the same to a video or an image that the user wants to shoot. At 317, the user 301 may see the effect on the display screen or the interface of the client 303 for shooting. At 319, when the user 301 starts shooting, the client 303 may obtain UGC data generated in real time. At 321, the client 303 provides the effect package 305 with an address of a temporary resource folder used to store the UGC data. At 323, the effect package 305 writes the UGC data to the temporary resource folder. At 325, the client 303 may obtain the UGC data in segments based on a preset period of time. When shooting a plurality of segments in succession, at 327, the client 303 may generate a null address, that is, an invalid address, for a non-first segment. At 329, when receiving the null address sent by the client 303, the effect package 305 does not write UGC data with empty payload. That is, whether or not the UGC data is stored is controlled by the client 303. When it is not necessary to store the UGC data, the null address may be sent to the effect packet 305.

At 331, when the client 303 detects that the user 301 ends shooting, it means that no new UGC data is generated. At 333, the client 303 packages and compresses the stored UGC data. At 335, the compressed UGC data is sent from the client 303 to the server 307. At 337, the server 307 stores the received UGC data in an established database system and generates a UGC identifier based on the UGC data. At 339, the UGC identifier is sent from the server 307 to the client 303. At 341, the server 307 sends the UGC data to the security moderation platform 309 for moderation to filter out sensitive information. At 343, the security moderation platform 309 may use a moderating model to moderate the UGC data, where a type of moderating model may be selected according to an actual need, and is not limited in the present disclosure. At 345, the security moderation platform 309 returns a moderation result to the server 307, and the server 307 may reject a sending request for the UGC data when the moderation result does not meet a predetermined condition.

At 347, the user 301 chooses to upload a shot effect-based work. At 349, the client 303 writes the effect-based work and the UGC identifier corresponding to the effect-based work to an upload interface of the server 307. At 351, the server 307 writes the effect-based work to a work processing model. At 353, the user 301 chooses to share the shot effect-based work with a different user. At 355, the UGC identifier is written to a message sent to a client of the different user. At 357, the UGC identifier is sent from the server 307 to a peer to implement a subsequent collaborative shooting process.

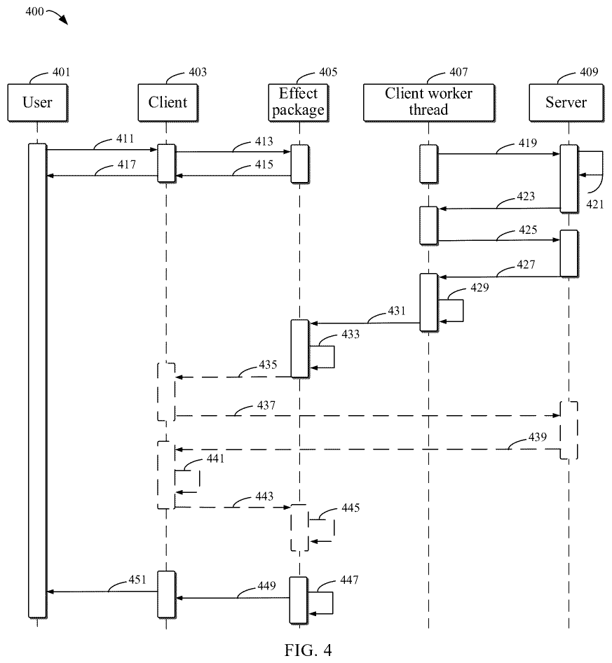

FIG. 4 is a timing diagram of performing collaborative shooting by using a UGC identifier according to some embodiments of the present disclosure. Refer to FIG. 1. A collaborative shooting process includes a communication process between the user 109, the client 111, and the server 107. Therefore, a user 401 in FIG. 4 is consistent with the user 109 in FIG. 1, a client 403 is consistent with the client 111, and a server 409 is consistent with the server 107. When the user 401 watches the effect-based work from the shooting by the user 301 on the client 403, the client 403 may obtain the UGC identifier together with the effect-based work from the server 409 or the client 303 at the same time, as the UGC data of the user 301 is sent along with the effect-based work. FIG. 4 further includes an effect package 405. The effect package 405 is configured to perform processing such as decoding and rendering on an effect on the client 403, to display the effect on a device of the client 403. Specific steps for obtaining an effect are described below. At 411, when the user 401 wants to shoot using an effect, an instruction for applying the effect may be sent to the client 403 by using a control or link displayed on the client 403. At 413, the client 403 sends an effect rendering message to the effect package 405 after receiving the instruction for applying the effect. At 415, the effect package 405 displays the effect on a display screen or interface of the client 403 after receiving the effect rendering message, and applies the same to a video or an image that the user wants to shoot. At 417, the user 401 may see, on the display screen or interface of the client 403, a same effect as the effect used by the user 301.

In some embodiments, after rendering the same effect as that used by the user 301, a client worker thread 407 may request the UGC data for the user 301 from the server 409 to implement aggregation of effect-based works of different users. At 419, a UGC identifier is sent from the client worker thread 407 to the server 409. At 421, the server 409 queries a database system for a uniform resource locator (URL) and a moderation status of the UGC data corresponding to the UGC identifier. At 423, after the URL and the moderation status of the UGC data are determined, the URL may be sent from the server 409 to the client worker thread 407. At 425, after receiving the URL, the client worker thread 407 can download compressed UGC data by using the URL. At 427, after the download is successful, the compressed UGC data is sent from the server 409 to the client worker thread 407. At 429, the client workload thread 407 decompresses the UGC data. At 431, after the UGC data is decompressed, the file address of the UGC data is sent from the client worker thread 407 to the effect package 405. At 433, the effect package 405 parses the UGC data based on the file address. At 447, the effect package 405 processes the UGC data. At 449, the effect package 405 renders the UGC data onto the screen or interface of the client 403. At 451, the user 401 can watch the UGC data of the user 301 by using the client 403.

In some embodiments, the client 403 may further display an avatar picture of the user 301. At 435, when a request message for a specified avatar is detected, a user identifier is passed from the effect packet 405 to the client 403 without modification. At 437, the client 403 obtains a link of the avatar picture through an interface of the server 409. At 439, the link of the avatar picture is sent from the server 409 to the client 403. At 441, the client 403 downloads the specified avatar based on the link of the avatar picture. At 443, the client 403 sends an avatar local path to the effect package 405. At 445, the effect package 405 renders the specified avatar by using the avatar local path.

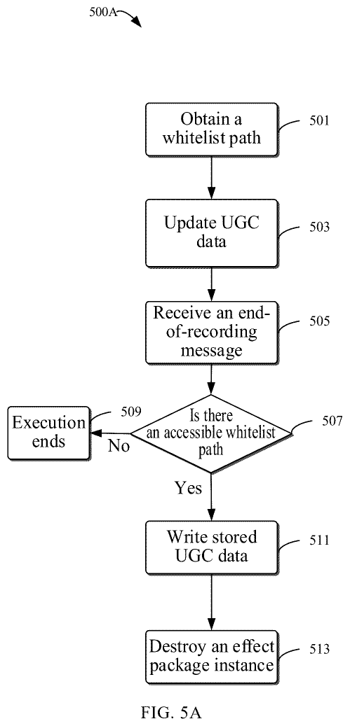

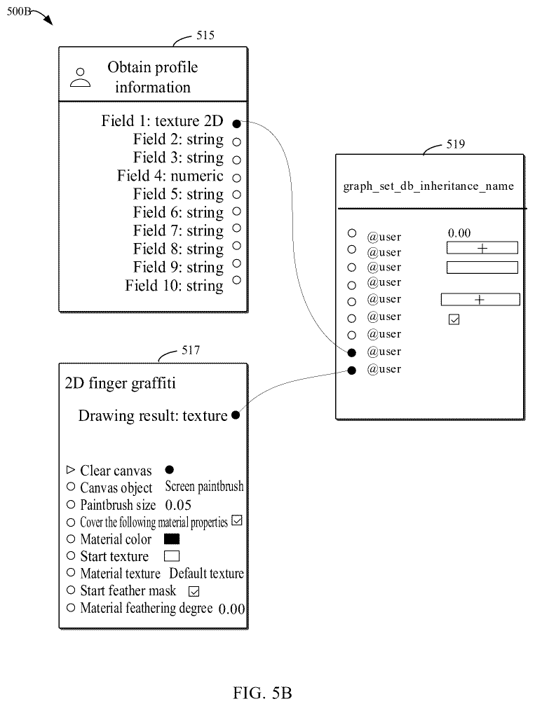

FIG. 5A is a flowchart of a method for writing UGC data to a temporary resource folder by an effect side according to some embodiments of the present disclosure. Refer to FIG. 3. The effect side is consistent with the effect package 305, and is configured to process and render an effect on the client 303. At block 501, a whitelist path is obtained. Refer to FIG. 3. When the user 301 starts shooting, the client 303 may obtain the UGC data generated in real time. In this case, the client 303 provides the effect package 305 with an address of the temporary resource folder used to store the UGC data, and opens a read/write permission of the resource folder. Obtaining of a whitelist path may also be referred to as obtaining an address of a readable/writable resource folder. At block 503, UGC data is updated. The UGC data generated in real time may be written to a data-writable resource folder in segments by using an address of the resource folder, that is, the whitelist path. At block 505, an end-of-recording message is received. Refer to FIG. 3. When the client 303 detects that the user 301 ends shooting, it means that no new UGC data is generated. In this case, recording ends. The end-of-recording message may be triggered by an operation performed by the user 301 on a specific control in the client 303 or may be automatically generated within a preset recording pause time. At 507, whether there is an accessible whitelist path is determined, that is, whether there is the address of the data-writable resource folder is determined. When there is no accessible whitelist path, block 509 is performed: End execution. When there is the accessible whitelist path, block 511 is performed to write the UGC data to the resource folder. Finally, block 513 is performed: Destroy an effect package instance.

FIG. 5B is a schematic diagram of writing UGC data to a temporary resource folder according to some embodiments of the present disclosure. As shown in FIG. 5B, after the UGC data is obtained, the UGC data may be classified and structuralized. For example, the UGC data may be classified into user information 515 and user operation data 517. The classified and structuralized UGC data is correspondingly summarized to each user name 519. When the UGC data needs to be obtained, the UGC data may be quickly addressed and obtained by using the user name 519 as an index.

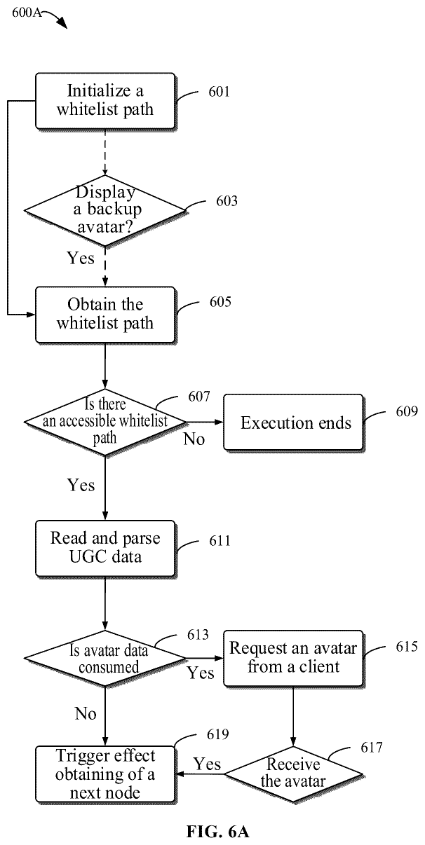

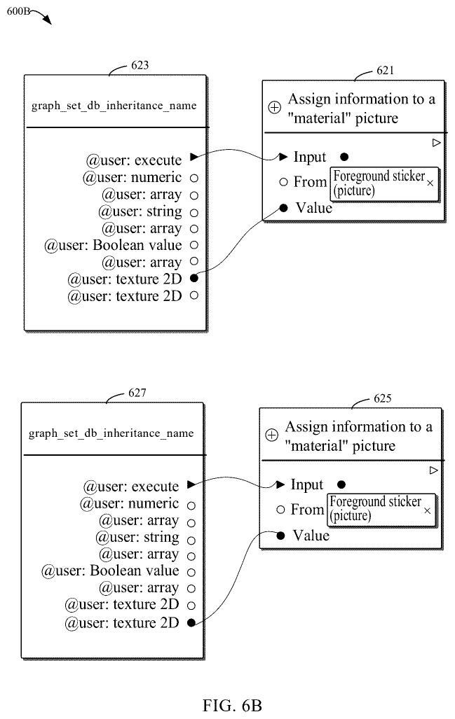

FIG. 6A is a flowchart of a method for obtaining UGC data according to some embodiments of the present disclosure. At block 601, a whitelist path is initialized. Refer to FIG. 4. The whitelist path is the address of the resource folder that is provided by the client 403 to the effect package 405 for reading the UGC data. The whitelist path needs to be initialized before the whitelist path is obtained. At block 603, whether a backup avatar needs to be displayed is determined. In some embodiments, whether the backup avatar needs to be displayed is determined based on parsed UGC data. In some embodiments, the backup avatar is displayed only when a system initiates an avatar display request but cannot pull avatar data. Refer to FIG. 4. Before the client 403 renders the UGC data generated from shooting by the user 301 based on the effect and the avatar of the user 301, the backup avatar may be rendered first. The backup avatar may include an avatar picture in a preset form, for example, an avatar of a blank page. This is not limited in the present disclosure. At block 605, the whitelist path is obtained. Obtaining of the whitelist path may also be referred to as obtaining an address of a UGC data readable resource folder. At block 607, whether there is an accessible whitelist path is determined. When there is no accessible whitelist path, block 609 is performed: End execution. When there is the accessible whitelist path, block 611 is performed, that is, “Read and parse UGC data”, to render an effect of the UGC data.

In some embodiments, the avatar picture of the user may be further displayed. At block 613, whether avatar data is consumed is determined, that is, whether a request message for a specified avatar is detected is determined. At block 615, when the request message for the specified avatar is detected, an effect package may request a client for an avatar, and the client may send an avatar local path to the effect package. At block 617, the effect package obtains the avatar by using the avatar local path and renders the specified avatar. At block 619, effect obtaining of a next node is triggered.

FIG. 6B is a schematic diagram of receiving UGC data according to some embodiments of the present disclosure. As shown in FIG. 6B, whether UGC data corresponding to a user needs to be performed may be determined by using a user name as an index when the UGC data needs to be rendered. When it is determined that the UGC data needs to be rendered, stored information corresponding to the user name may be assigned to a picture to implement rendering. For example, texture information stored under a user name 623 is rendered onto a picture, where an interface 621 is a display interface used when the UGC data corresponding to the user name 623 is rendered. For another example, texture information stored under a user name 627 is rendered onto a picture, where an interface 625 is a display interface used when the UGC data corresponding to the user name 627 is rendered.

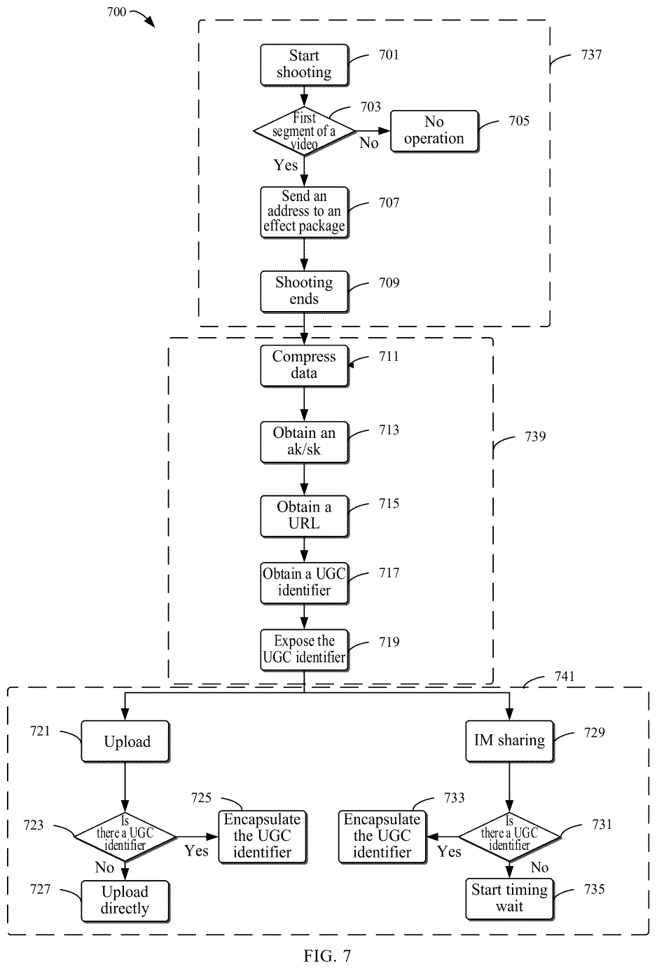

FIG. 7 is a flowchart of a method for obtaining a UGC identifier on a client and writing the UGC identifier to a message according to some embodiments of the present disclosure. Refer to FIG. 7. Obtaining of the UGC identifier on the client and writing of the UGC identifier to the message may include a shooting process 737, an editing process 739, and a posting process 741. The shooting process 737 includes block 701, block 703, block 705, block 707, and block 709. At block 701, shooting starts. The client may determine, by detecting a shooting operation of a user, whether to start shooting. At block 703, whether shot data is the first segment of a shot video is determined. When the shot data is not the first segment of the shot video, block 705 is performed: No operation. When the shot data is the first segment of the shot video, block 707 is performed: Send an address to an effect package. The client sends an address of a data-readable/writable resource folder to the effect package, so that the effect package can write UGC data to the resource folder. The process ends at block 709: Shooting ends.

Still referring to FIG. 7. The editing process 739 may include block 711, block 713, block 715, block 717, and block 719. At block 711, data is compressed. In response to shooting ending, the client may package and compress the stored UGC data. At block 713, an access key/security key (ak/sk) is obtained. ak/sk authentication may ensure that only an authorized user can access and invoke a specific application programming interface (API). At block 715, the client may obtain a URL of the UGC identifier from the server by using the ak/sk. At block 717, the UGC identifier is obtained. After obtaining the URL, the client may obtain the UGC identifier from the server by using the URL. At block 719, the UGC identifier is exposed, so that the UGC identifier can be a full-scenario generic string.

Still referring to FIG. 7. The posting process 741 may include block 721, block 723, block 725, block 727, block 729, block 731, block 733, and block 735. At block 721, the user chooses to upload an effect-based work. Block 723 needs to be performed before uploading: Determine whether there is a corresponding UGC identifier in the effect-based work. When there is the UGC identifier, block 725 is performed, that is, “Encapsulate the UGC identifier”, so that the UGC identifier can be distributed with distribution of the effect-based work. When there is no UGC identifier, block 727 is performed: Upload directly. At block 729, the user chooses to share the effect-based work with a different user by using an instant messaging (IM) message. Block 731 needs to be performed before sharing: Determine whether there is a corresponding UGC identifier in the effect-based work. When there is the UGC identifier, block 733 is performed, that is, “Encapsulate the UGC identifier”, so that the UGC identifier can be distributed with distribution of the effect-based work. When there is no UGC identifier, block 735 is performed: Start sharing timing wait.

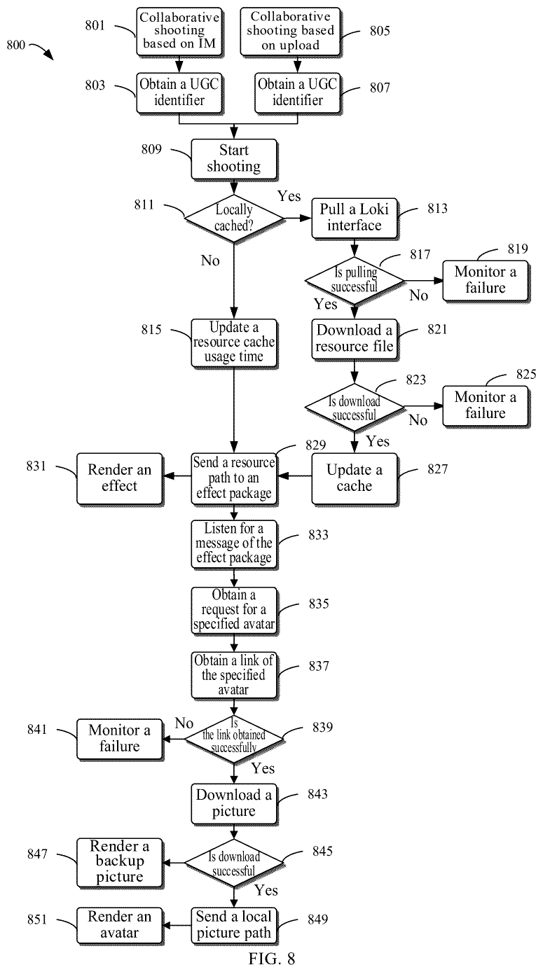

FIG. 8 is a flowchart of a method for rendering an effect and a user avatar on a client based on a UGC identifier according to some embodiments of the present disclosure. Refer to FIG. 7. The user may choose to upload and share the effect-based work. Refer back to FIG. 8. At block 801, a different user may perform collaborative shooting on the effect-based work shared by using the IM message. At block 805, the different user may alternatively perform collaborative shooting on the uploaded effect-based work. At block 803 and block 807, a UGC identifier corresponding to the uploaded or shared effect-based work is obtained. A sharing scenario is that a user shares content with a specified friend and wants the friend to perform collaborative shooting. Therefore, in this scenario, there is a strong need for carrying the UGC identifier. The client waits for the UGC data processing to be completed, to ensure that the UGC identifier can be carried. However, in an uploading scenario, an increase in a posting duration may reduce a success rate of uploading. Therefore, in the uploading scenario, only generation of the UGC identifier is monitored, and it is not necessary to wait for completion of generation of the UGC identifier.

At block 809, shooting is started based on an effect. The effect in this case is the same as that of the effect-based work for collaborative shooting. At block 811, whether UGC data corresponding to the obtained UGC identifier is locally cached is determined. When the UGC data is not locally cached, block 815 is performed: Update a resource cache usage time. When the UGC data is locally cached, block 813 is performed to pull an interface of a Loki server. The interface of the Loki server is configured to download a resource file of the UGC data. At block 817, whether pulling is successful is determined. When pulling of the interface is failed, block 819 is performed: Monitor a failure. The client controls whether or not the entire process is blocked in different distribution scenarios through a timeout monitoring mechanism. When pulling of the interface is successful, block 821 is performed to download the resource file of the UGC data from the Loki server through the interface of the Loki server. At block 823, whether download is successful is determined. When the download is failed, block 825 is performed: Monitor a failure. When the download is successful, block 827 is performed to update the cached UGC data. At block 829, the client sends a resource path to an effect package, so that the effect package can read the updated UGC data from the resource folder of the client. At block 831, the effect package renders the UGC data onto the client after obtaining the UGC data by using the resource path.

In some embodiments, a user avatar of a collaborative shooting effect-based work may be further displayed on the client. At block 833, a message from the effect package is listened for, to determine whether there is a request message for a specified avatar. At block 835, when the request message for the specified avatar is detected, a user identifier is passed from the effect package to the client without modification, to perform block 837 to obtain an image link of an avatar. At block 839, whether an avatar link is successfully obtained is determined. When the avatar link is not successfully obtained, block 841 is performed: Monitor a failure. When the avatar link is successfully obtained, block 843 is performed to download the specified avatar by the client based on the avatar link. At block 845, whether download is successful is determined. When the download is failed, block 847 is performed: Render a backup picture. The backup picture is consistent with the backup avatar in FIG. 6A. Details are not described herein again. When the download is successful, block 849 is performed to send an avatar local picture path to the effect package by the client 403, to perform block 851 to render the specified avatar by using the avatar local picture path.

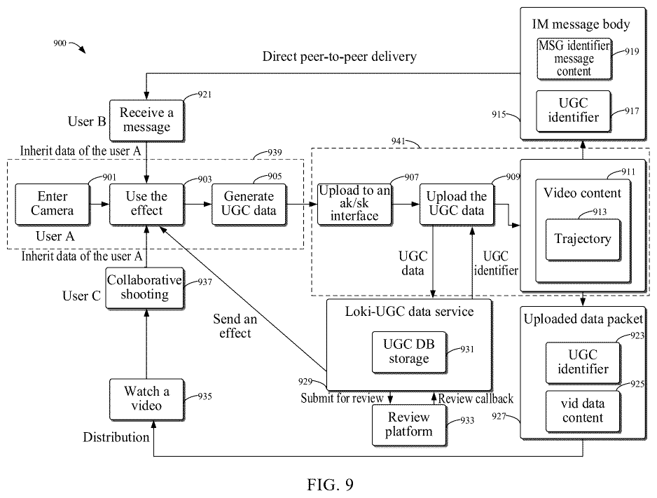

FIG. 9 is a schematic diagram of an overall link for generating a UGC identifier and rendering an effect based on the UGC identifier according to some embodiments of the present disclosure. Refer to FIG. 9. A process of generating the UGC identifier includes a shooting process 939 and an editing process 941. The shooting process includes block 901, block 903, and block 905. At block 901, a user A enters Camera. At block 903, the user starts shooting based on an effect. At block 905, UGC data is generated through the shooting operation of the user A. The editing process 941 includes block 907 and block 909. At block 907, a client obtains an ak/sk interface to perform block 909 to upload the UGC data to a server 929. After receiving the UGC data, the server 929 may store the UGC data in a database system 931 and send the UGC data to a moderation platform 933 for moderation. After receiving the UGC data, the server 929 may further perform sharing or distribution processing based on an indication of the user A. An effect-based work may include video content 911. The video content 911 may include data such as a trajectory, picture texture, and text information.

Refer to FIG. 9. The effect-based work may be shared with a user B by using an IM message body 915, and the user B may inherit the UGC data of the user A after receiving a message 921, to perform collaborative shooting. In some embodiments, the IM message body may include message content 919 and a UGC identifier 917. An IM sharing scenario has strong privacy and a low requirement for content security of a UGC resource. When a link is shared by using an IM message for collaborative shooting, if the UGC data is being moderated, it is not necessary to wait for a moderation result, and the data may be directly delivered. Therefore, the client adds a scenario identifier to the collaborative shooting link of the IM message to perform secondary encapsulation on the UGC identifier, and passes the UGC identifier to Camera without modification. The scenario identifier is used when a Loki server is requested to deliver the UGC resource. Still referring to FIG. 9. The effect-based work may be posted to a user C by using an uploaded data packet 927 including a UGC identifier 923 and vid data content 925. The user C triggers a collaborative shooting operation 937 when watching an effect video 935, to inherit the UGC data of the user A for collaborative shooting.

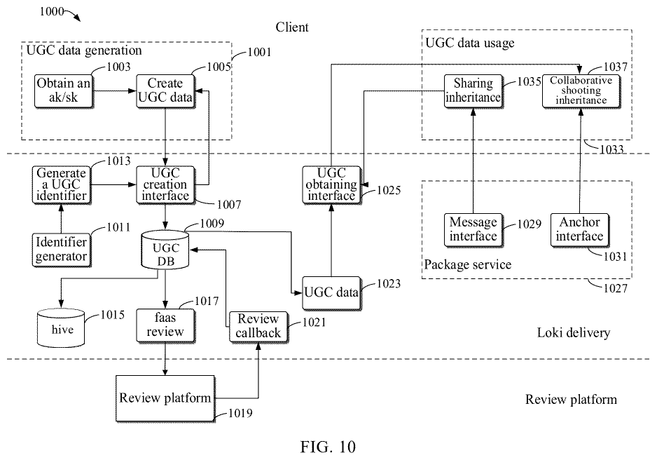

FIG. 10 is a schematic diagram of an overall link for delivering a UGC identifier and UGC data by a Loki server according to some embodiments of the present disclosure. Refer to FIG. 10. UGC data generation may include block 1003 and block 1005. Methods and processes for obtaining an ak/sk at block 1003 and generating the UGC data at block 1005 are consistent with those described above. Details are not described herein again. After the UGC data is generated, a video cloud storage generates storage address information. A client invokes a UGC creation interface 1007 of a delivery platform of the Loki server, sends information such as the UGC data, a user identifier, and an effect identifier to a database system 1009 of the Loki server for storage, and an identifier generator 1011 in the Loki server generates a UGC identifier 1013. The UGC interface 1007 may implement transmission of the UGC data and the UGC identifier between the client and the Loki server.

Still referring to FIG. 10. After receiving the UGC data, the Loki server further performs block 1017: function as a service (faas) moderation. The UGC data is converted into a specified form required for moderation before being sent for moderation, and the converted UGC data is sent from the Loki server to a moderation platform 1019. At block 1021, a moderation status for the UGC data is received from the moderation platform 1019. In some embodiments, after the information such as the UGC data, the user identifier, and the effect identifier are sent to the database system 1009 of the Loki server for storage, the data stored in the database system 1009 may be further queried and analyzed by using data warehouse software 1015.

Still referring to FIG. 10. The Loki server receives UGC data creation information and moderation result change information of a moderation system, and packages 1027 the latest UGC data and stores the same in the database system 1009. The client implements sharing inheritance 1035 or collaborative shooting inheritance 1037 through an IM message sharing interface 1029 or an anchor interface 1031. When a user uses the inherited effect, the client obtains a download address of the UGC data through a UGC data obtaining interface 1025 of the Loki server. After downloading, a tool loads the UGC data and the user can inherit data information created by a previous user.

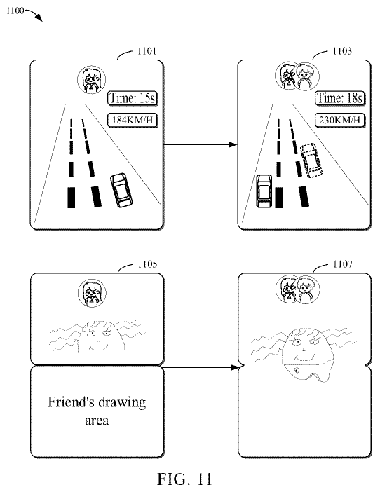

FIG. 11 is an effect diagram of implementing a method for obtaining an effect according to some embodiments of the present disclosure. As shown in FIG. 11, a display interface 1101 is a display interface for a video of a racing game played by a user A. The client may generate UGC data of the user A such as a driving trajectory, a vehicle location, a time, and a game result when the user A performs a game operation. When the game video of the user A is distributed to or shared with a client device of a user B, the client of the user B may render the UGC data of the user A, so that data of the user A and the user B is displayed simultaneously in a display interface 1103 of the client of the user B. In this case, the user B may adjust an operation thereof while watching a reference image of the user A.

Still referring to FIG. 11. A display interface 1105 is a display interface of a video of a drawing game played by a user A. The client may generate UGC data of the user A such as handwriting when the user A performs a game operation. When the game video of the user A is distributed to or shared with a client device of a user B, the client of the user B may render the UGC data of the user A, so that data of the user A and the user B is displayed simultaneously in a display interface 1107 of the client of the user B. Compared to an effect customization method, the present disclosure provides a novel social effect-fission play method with high flexibility, scalability, and reusability. In this solution, effect fission is implemented through UGC data transmission, thereby ensuring that a unique effect can be generated when each user uses a social effect. In addition, the user may further share the effect with a friend for co-creation, thereby greatly enriching effect plays.

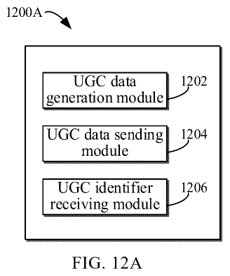

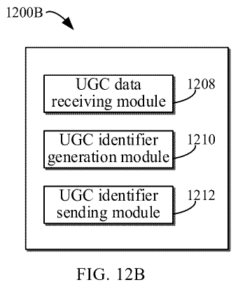

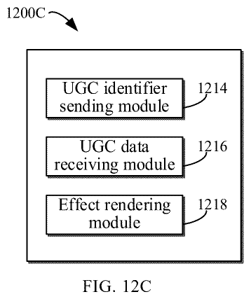

FIG. 12A is a block diagram of an apparatus 1200A for identifying an effect according to some embodiments of the present disclosure. The apparatus 1200A is deployed on a first client. As shown in FIG. 12A, the apparatus 1200A includes a UGC data generation module 1202 configured to generate first UGC data from shooting by a first user based on an effect. The apparatus 1200A further includes a UGC data sending module 1204 configured to send the first UGC data to a server. The apparatus 1200A further includes a UGC identifier receiving module 1206 configured to receive a first UGC identifier corresponding to the first UGC data from the server, where the first UGC identifier is used to identify the first UGC data generated from the shooting based on the effect.

FIG. 12B is a block diagram of an apparatus 1200B for generating an identifier of an effect according to some embodiments of the present disclosure. The apparatus 1200B is deployed on a server. As shown in FIG. 1200B, the apparatus 1200B includes a UGC data receiving module 1208 configured to receive, from a first client, first UGC data generated when a first user uses an effect. The apparatus 1200B further includes a UGC identifier generation module 1210 configured to generate a first UGC identifier corresponding to the first UGC data based on the first UGC data, where the first UGC identifier is used to identify the first UGC data generated from the shooting based on the effect. The apparatus 1200B further includes a UGC identifier sending module 1212 configured to send the first UGC identifier to the first client.

FIG. 12C is a block diagram of an apparatus 1200C for obtaining an effect according to some embodiments of the present disclosure. The apparatus 1200C is deployed on a second client. As shown in FIG. 12C, the apparatus 1200C includes a UGC identifier sending module 1214 configured to send a first UGC identifier corresponding to first UGC data to a server, where the first UGC data is from shooting by a user on a first client based on an effect. The apparatus 1200C further includes a UGC data receiving module 1216 configured to receive the first UGC data from the server. The apparatus 1200C further includes an effect rendering module 1218 configured to render the effect of the first UGC data based on the first UGC data, where a second user obtains second UGC data on the second client by shooting based on the effect, and the second user performs effect interaction on the second client based on the first UGC data and the second UGC data.

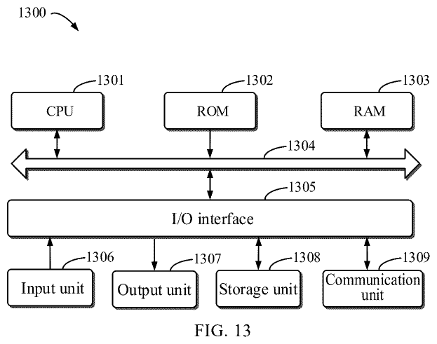

FIG. 13 is a block diagram of a device 1300 capable of implementing a plurality of embodiments of the present disclosure. As shown in FIG. 13, the device 1300 includes a central processing unit (CPU) and/or graphics processing unit (GPU) 1301 that may perform a variety of appropriate actions and processing in accordance with computer program instructions stored in a read-only memory (ROM) 1302 or computer program instructions loaded from a storage unit 1308 into a random-access memory (RAM) 1303. The RAM 1303 may further store various programs and data required for the operation of the device 1300. The CPU/GPU 1301, the ROM 1302, and the RAM 1303 are connected to each other via a bus 1304. An input/output (I/O) interface 1305 is also connected to the bus 1304. Although not shown in FIG. 13, the device 1300 may further include a coprocessor.

A number of components in the device 1300 are connected to the I/O interface 1305, including: an input unit 1306, such as a keyboard or a mouse; an output unit 1307, such as various types of displays or speakers; the storage unit 1308, such as a magnetic disk or an optical disk; and a communication unit 1309, such as a network card, a modem, or a wireless communication transceiver. The communication unit 1309 allows the device 1300 to exchange information/data with other devices over a computer network such as the Internet and/or various telecommunication networks.

Each method or process described above may be performed by the CPU/GPU 1301. For example, in some embodiments, the method may be implemented as a computer software program tangibly embodied in a machine-readable medium, such as the storage unit 1308. In some embodiments, some or all of the computer programs may be loaded into and/or installed onto the device 1300 via the ROM 1302 and/or the communication unit 1309. When the computer program is loaded into the RAM 1303 and executed by the CPU/GPU 1301, one or more steps or actions in the method or process described above may be performed.

In some embodiments, the methods and processes described above may be implemented as a computer program product. The computer program product may include a computer-readable storage medium on which computer-readable program instructions for performing various aspects of the present disclosure are carried.

The computer-readable storage medium may be a tangible device that can hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples of the computer-readable storage medium (a non-exhaustive list) include: a portable computer disk, a hard disk, a random-access memory (RAM), a read-only memory (ROM), an erasable programmable read-only memory (EPROM) (or a flash memory), a static random-access memory (SRAM), a portable compact disk read-only memory (CD-ROM), a digital versatile disk (DVD), a memory stick, a floppy disk, a mechanical coding device, a punched card or an in-groove raised structure on which instructions are for example stored, and any suitable combination thereof. The computer-readable storage medium used herein is not to be interpreted as a transient signal, such as a radio wave or another freely propagating electromagnetic wave, an electromagnetic wave propagating through a waveguide or another transmission medium (e.g., an optical pulse through a fiber-optic cable), or an electrical signal transmitted over a wire.

The computer-readable program instructions described herein may be downloaded from a computer-readable storage medium to each computing/processing device, or downloaded to an external computer or an external storage device over a network, such as the Internet, a local area network, a wide area network, and/or a wireless network. The network may include copper transmission cables, fiber-optic transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be completely executed on a computer of a user, partially executed on a computer of a user, executed as an independent software package, partially executed on a computer of a user and partially executed on a remote computer, or completely executed on a remote computer or server. In a case of the remote computer, the remote computer may be connected to the computer of the user through any kind of network, including a local area network (LAN) or a wide area network (WAN), or may be connected to an external computer (for example, connected through the Internet with the aid of an Internet service provider). In some embodiments, an electronic circuit, such as a programmable logic circuit, a field programmable gate array (FPGA), or a programmable logic array (PLA), is personalized by using status information of the computer-readable program instructions. The electronic circuit may execute the computer-readable program instructions to implement various aspects of the present disclosure.

These computer-readable program instructions may be provided to a processing unit of a general-purpose computer, a special-purpose computer, or another programmable data processing apparatus to produce a machine, such that the instructions, when executed by the processing unit of the computer or the other programmable data processing apparatus, create an apparatus for implementing functions/actions specified in one or more blocks in the flowchart and/or the block diagrams. These computer-readable program instructions may alternatively be stored in the computer-readable storage medium. These instructions enable a computer, a programmable data processing apparatus, and/or another device to work in a specific manner. Therefore, the computer-readable medium storing the instructions includes an artifact that includes instructions for implementing various aspects of functions/actions specified in one or more blocks in the flowchart and/or the block diagrams.

Alternatively, the computer-readable program instructions may be loaded onto a computer, another programmable data processing apparatus, or another device, such that a series of operation steps are performed on the computer, the other programmable data processing apparatus, or the other device to produce a computer-implemented process. Therefore, the instructions executed on the computer, the other programmable data processing apparatus, or the other device implement functions/actions specified in one or more blocks in the flowchart and/or the block diagrams.

The flowcharts and the block diagrams in the accompanying drawings illustrate possible system architectures, functions, and operations of the device, the method, and the computer program product according to a plurality of embodiments of the present disclosure. In this regard, each block in the flowcharts or the block diagrams may represent a part of a module, a program segment, or an instruction. The part of the module, the program segment, or the instruction includes one or more executable instructions for implementing a specified logical function. In some alternative implementations, functions tokenized in the blocks may occur in a sequence different from that tokenized in the accompanying drawings. For example, two consecutive blocks may actually be executed substantially in parallel, or may sometimes be executed in a reverse order, depending on a function involved. It should also be noted that each block in the block diagrams and/or the flowcharts, and a combination of the blocks in the block diagrams and/or the flowcharts may be implemented by a dedicated hardware-based system that executes specified functions or actions, or may be implemented by a combination of dedicated hardware and computer instructions.

Various embodiments of the present disclosure have been described above. The foregoing descriptions are exemplary, not exhaustive, and are not limited to the disclosed embodiments. Many modifications and variations are apparent to a person of ordinary skill in the art without departing from the scope and spirit of the described embodiments. The terminology used in this specification is intended to best explain the principles, practical applications, or technical improvements in the market of the embodiments, or to enable others of ordinary skill in the art to understand the embodiments disclosed herein.

Some example implementations of the present disclosure are listed below.

Example 1. A method for identifying an effect, where the method is performed by a first client, and the method includes:
generating first UGC data from shooting by a first user based on an effect;
sending the first UGC data to a server; and
receiving a first UGC identifier corresponding to the first UGC data from the server, where the first UGC identifier is used to identify the first UGC data generated from the shooting based on the effect.

Example 2. The method of Example 1, where generating the first UGC data from the shooting by the first user based on the effect includes:
generating a temporary resource folder at the first client in response to the first user starting shooting based on the effect;
opening a permission for the temporary resource folder to an effect side;
providing an address of the temporary resource folder to the effect side; and
writing, by the effect side, the first UGC data to the temporary resource folder.

Example 3. The method of any of Examples 1 to 2, where sending the first UGC data to the server includes:
compressing the first UGC data in response to the shooting being completed; and
sending the compressed first UGC data from the first client to the server.

Example 4. The method of any of Examples 1 to 3, further including:
writing the first UGC identifier to a message in response to the first user sharing the first UGC data with a second user of a second client; and
sending the message carrying the first UGC identifier from the first client to the second client.

Example 5. A method for generating an identifier of an effect, where the method is performed by a server, and the method includes:
receiving, from a first client, first UGC data generated in response to a first user using an effect;
generating a first UGC identifier corresponding to the first UGC data based on the first UGC data, where the first UGC identifier is used to identify the first UGC data generated from shooting based on the effect; and
sending the first UGC identifier to the first client.

Example 6. The method of Example 5, further including:
converting, in response to receiving the first UGC data, the first UGC data into a specified form required for moderation;
sending the converted first UGC data from the server to a moderation platform; and
receiving a moderation status for the first UGC data from the moderation platform.

Example 7. The method of any of Examples 5 to 6, further including:
determining a resource address and the moderation status of the first UGC data corresponding to the first UGC identifier in response to receiving the first UGC identifier; and
obtaining the first UGC data by using the resource address in response to the moderation status meeting a predetermined condition; and
performing decompression and sending the first UGC data to a second client.

Example 8. The method of any of Examples 5 to 7, further including:
rejecting access of the second client to the first UGC data in response to the moderation status not meeting the predetermined condition.

Example 9. The method of any of Examples 5 to 8, further including:
listening for a message that comes from the second client and that requests a specified avatar; and
sending an image link of the specified avatar from the server to the second client in response to receiving the message that requests the specified avatar.

Example 10. A method for obtaining an effect, where the method is performed by a second client, and the method includes:
sending a first UGC identifier corresponding to first UGC data to a server, where the first UGC data is from shooting by a first user on a first client based on an effect;
receiving the first UGC data from the server; and
rendering the effect of the first UGC data based on the first UGC data, where
a second user obtains second UGC data on the second client by performing shooting based on the effect, and
the second user performs effect interaction on the second client based on the first UGC data and the second UGC data.

Example 11. The method of Example 10, further including:
receiving, by the second client, the first UGC identifier shared by the first user from the first client.

Example 12. The method of any of Examples 10 to 11, further including:
receiving, by the second client from the server, the first UGC identifier distributed by the server.

Example 13. The method of any of Examples 10 to 12, where sending the first UGC identifier corresponding to the first UGC data to the server includes:
sending the first UGC identifier from the second client to the server in response to the second user of the second client initiating a collaborative shooting.

Example 14. The method of any of Examples 10 to 13, where the receiving the first UGC data from the server includes:
receiving, by the second client, a resource address of the first UGC data from the server; and
receiving the first UGC data based on the resource address.

Example 15. The method of any of Examples 10 to 13, further including:
sending a message of a specified avatar from the second client to the server in response to receiving a touch operation performed by the second user of the second client on an avatar control;
receiving, by the second client, an image link of the specified avatar from the server;
downloading the specified avatar based on the image link of the specified avatar; and
displaying the specified avatar on the second client in response to the specified avatar being successfully downloaded.

Example 16. An apparatus for identifying an effect, where the apparatus is deployed on a first client, and the apparatus includes:
a UGC data generation module configured to generate first UGC data from shooting by a first user based on an effect;
a UGC data sending module configured to send the first UGC data to a server; and
a UGC identifier receiving module configured to receive a first UGC identifier corresponding to the first UGC data from the server, where the first UGC identifier is used to identify the first UGC data generated from the shooting based on the effect.

Example 17. The apparatus of Example 16, where the UGC data generation module includes:
a temporary resource folder generation module configured to generate a temporary resource folder at the first client in response to the first user starting shooting using the effect;
a permission opening module configured to open a permission for the temporary resource folder to an effect side;
an address providing module configured to provide an address of the temporary resource folder to the effect side; and
a UGC data write module configured to write, by the effect side, the first UGC data to the temporary resource folder.

Example 18. The apparatus of any of Examples 16 to 17, where the UGC data sending module includes:
a UGC data compression module configured to compress the first UGC data in response to the shooting being completed; and
a first UGC data sending module configured to send the compressed first UGC data from the first client to the server.

Example 19. The apparatus of any of Examples 16 to 18, further including:
a UGC identifier write module configured to write the first UGC identifier to a message in response to the first user sharing the first UGC data with a second user of a second client; and
a message sending module configured to send the message carrying the first UGC identifier from the first client to the second client.

Example 20. An apparatus for generating an identifier of an effect, where the apparatus is deployed on a server, and the apparatus includes:
a UGC data receiving module configured to receive, from a first client, first UGC data generated in response to a first user using an effect;
a UGC identifier generation module configured to generate a first UGC identifier corresponding to the first UGC data based on the first UGC data, where the first UGC identifier is used to identify the first UGC data generated from the shooting based on the effect; and
a UGC identifier sending module configured to send the first UGC identifier to the first client.

Example 21. The apparatus of Example 20, further including:
a UGC data conversion module configured to convert, in response to receiving the first UGC data, the first UGC data into a specified form required for moderation;
a second UGC data sending module configured to send the converted first UGC data to a moderation platform; and
a moderation status receiving module configured to receive a moderation status for the first UGC data from the moderation platform.

Example 22. The apparatus of any of Examples 20 to 21, further including:
a resource address determination module configured to determine a resource address and the moderation status of the first UGC data corresponding to the first UGC identifier in response to receiving the first UGC identifier from a second client; and
a UGC data obtaining module configured to obtain the first UGC data by using the resource address in response to the moderation status meeting a predetermined condition; and
a third UGC data sending and obtaining module configured to perform decompression and send the first UGC data from the server to the second client.

Example 23. The apparatus of any of Examples 20 to 22, further including:
an access reject module configured to reject access of the second client to the first UGC data in response to the moderation status not meeting the predetermined condition.

Example 24. The apparatus of any of Examples 20 to 23, further including:
a listening module configured to listen for a message that comes from the second client and that requests a specified avatar; and
an avatar request module configured to send an image link of the specified avatar from the server to the second client in response to receiving the message that requests the specified avatar.

Example 25. An apparatus for obtaining an effect, where the apparatus is deployed on a second client, and the apparatus includes:
a UGC identifier sending module configured to send a first UGC identifier corresponding to first UGC data to a server, where the first UGC data is generated from shooting by a first user on a first client based on an effect;
a UGC data receiving module configured to receive the first UGC data from the server; and
an effect rendering module configured to render the effect of the first UGC data based on the first UGC data, where
a second user obtains second UGC data on the second client by performing shooting based on the effect, and
the second user performs effect interaction on the second client based on the first UGC data and the second UGC data.

Example 26. The apparatus of example 25, further including:
a first identifier receiving module configured to receive, by the second client, the first UGC identifier shared by the first user from the first client.

Example 27. The apparatus of any of Examples 25 to 26, further including:
a second identifier receiving module configured to receive, by the second client from the server, the first UGC identifier distributed by the server.

Example 28. The apparatus of any of Examples 25 to 27, where the UGC identifier sending module includes:
a first identifier sending module configured to send the first UGC identifier from the second client to the server in response to the second user of the second client initiating a collaborative shooting.

Example 29. The apparatus of any of Examples 25 to 28, where the UGC data receiving module includes:
an address receiving module configured to receive, by the second client, a resource address of the first UGC data from the server; and
a first data receiving module configured to receive, by the second client, the first UGC data from the server based on the resource address.

Example 30. The apparatus of any of Examples 25 to 29, further including:
an avatar message sending module configured to send a message of a specified avatar from the second client to the server in response to receiving a touch operation performed by the second user of the second client on an avatar control;
an image link receiving module configured to receive, by the second client, an image link of the specified avatar from the server;
a specified avatar download module configured to download the specified avatar based on the image link of the specified avatar; and
a specified avatar display module configured to display the specified avatar on the second client in response to the specified avatar being successfully downloaded.

Example 31. An electronic device, including:
a processor; and
a memory coupled to the processor, where the memory has stored therein instructions that, when executed by the processor, cause the electronic device to perform actions including:
generating first UGC data from shooting by a first user based on an effect;
sending the first UGC data to a server; and
receiving a first UGC identifier corresponding to the first UGC data from the server, where the first UGC identifier is used to identify the first UGC data generated from the shooting based on the effect.

Example 32. The electronic device of Example 30, where generating the first UGC data from the shooting by the first user based on the effect includes:
generating a temporary resource folder at the first client in response to the first user starting shooting based on the effect;
opening a permission for the temporary resource folder to an effect side;
providing an address of the temporary resource folder to the effect side; and
writing, by the effect side, the first UGC data to the temporary resource folder.

Example 33. The electronic device of any of Examples 31 to 32, where sending the first UGC data to the server includes:
compressing the first UGC data in response to the shooting being completed; and
sending the compressed first UGC data from the first client to the server.

Example 34. The electronic device of any of Examples 31 to 33, where the actions further include:
writing the first UGC identifier to a message in response to the first user sharing the first UGC data with a second user of a second client; and
sending the message carrying the first UGC identifier from the first client to the second client.

Example 35. An electronic device, including:
a processor; and
a memory coupled to the processor, where the memory has stored therein instructions that, when executed by the processor, cause the electronic device to perform actions including:
receiving, from a first client, first UGC data generated in response to a first user using an effect;
generating a first UGC identifier corresponding to the first UGC data based on the first UGC data, where the first UGC identifier is used to identify the first UGC data generated from shooting based on the effect; and
sending the first UGC identifier to the first client.

Example 36. The electronic device of Example 35, where the actions further include:
converting, in response to receiving the first UGC data, the first UGC data into a specified form required for moderation;
sending the converted first UGC data from the server to a moderation platform; and
receiving a moderation status for the first UGC data from the moderation platform.

Example 37. The electronic device of any of Examples 35 to 36, where the actions further include:
determining a resource address and the moderation status of the first UGC data corresponding to the first UGC identifier in response to receiving the first UGC identifier from a second client; and
obtaining the first UGC data by using the resource address in response to the moderation status meeting a predetermined condition; and
performing decompression and sending the first UGC data from the server to the second client.

Example 38. The electronic device of any of Examples 35 to 37, where the actions further include:
rejecting access of the second client to the first UGC data in response to the moderation status not meeting the predetermined condition.

Example 39. The electronic device of any of Examples 35 to 38, where the actions further include:
listening for a message that comes from the second client and that requests a specified avatar; and
sending an image link of the specified avatar from the server to the second client in response to receiving the message that requests the specified avatar.

Example 40. An electronic device, including: a processor; and a memory coupled to the processor, where the memory has stored therein instructions that, when executed by the processor, cause the electronic device to perform actions including:
sending a first UGC identifier corresponding to first UGC data to a server, where the first UGC data is generated from shooting by a first user on a first client based on an effect;
receiving the first UGC data from the server; and
rendering the effect of the first UGC data based on the first UGC data, where
a second user obtains second UGC data on a second client by shooting based on the effect, and
the second user performs effect interaction on the second client based on the first UGC data and the second UGC data.

Example 41. The electronic device of Example 40, where the actions further include:
receiving, by the second client, the first UGC identifier shared by the first user from the first client.

Example 42. The electronic device of any of Examples 40 to 41, where the actions further include:
receiving, by the second client from the server, the first UGC identifier distributed by the server.

Example 43. The electronic device of any of Examples 40 to 42, where sending the first UGC identifier corresponding to the first UGC data to the server includes:
sending the first UGC identifier from the second client to the server in response to the second user of the second client initiating a collaborative shooting.

Example 44. The electronic device of any of Examples 40 to 43, where receiving the first UGC data from the server includes:
receiving, by the second client, a resource address of the first UGC data from the server; and
receiving, by the second client, the first UGC data from the server based on the resource address.

Example 45. The electronic device of any of Examples 40 to 44, where the actions further include:
sending a message of a specified avatar from the second client to the server in response to receiving a touch operation performed by the second user of the second client on an avatar control;
receiving, by the second client, an image link of the specified avatar from the server;
downloading the specified avatar based on the image link of the specified avatar; and
displaying the specified avatar on the second client in response to the specified avatar being successfully downloaded.

Example 46. A computer-readable storage medium having computer-executable instructions stored thereon, where the computer-executable instructions are executed by a processor to implement the method of any of Examples 1 to 15.

Example 47. A computer program product tangibly stored on a computer-readable medium and including computer-executable instructions that, when executed by a device, cause the device to perform the method of any of Examples 1 to 15.

Although the present disclosure has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. A method for identifying an effect, wherein the method is performed by a first client, and the method comprises:
generating first user-generated content (UGC) data from shooting by a first user based on an effect;
sending the first UGC data to a server; and
receiving a first UGC identifier corresponding to the first UGC data from the server, wherein the first UGC identifier is used to identify the first UGC data generated from the shooting based on the effect.

2. The method of claim 1, wherein generating the first UGC data from the shooting by the first user based on the effect comprises:
generating a temporary resource folder at the first client in response to the first user starting shooting based on the effect;
opening a permission for the temporary resource folder to an effect side;
providing an address of the temporary resource folder to the effect side; and
writing, by the effect side, the first UGC data to the temporary resource folder.

3. The method of claim 1, wherein sending the first UGC data to the server comprises:
compressing the first UGC data in response to the shooting being completed; and
sending the compressed first UGC data from the first client to the server.

4. The method of claim 1, further comprising:
writing the first UGC identifier to a message in response to the first user sharing the first UGC data with a second user of a second client; and
sending the message carrying the first UGC identifier from the first client to the second client.

5. The method of claim 2, wherein the temporary resource folder is configured to store the first UGC data locally at the first client.

6. The method of claim 2, wherein the effect side comprises an effect package configured to process, render and display the effect on the first client.

7. A method for generating an identifier of an effect, wherein the method is performed by a server, and the method comprises:
receiving, from a first client, first user-generated content (UGC) data generated in response to a user using an effect;
generating a first UGC identifier corresponding to the first UGC data based on the first UGC data, wherein the first UGC identifier is used to identify the first UGC data generated from shooting based on the effect; and
sending the first UGC identifier to the first client.

8. The method of claim 7, further comprising:
converting, in response to receiving the first UGC data, the first UGC data into a specified form required for moderation;
sending the converted first UGC data from the server to a moderation platform; and
receiving a moderation status for the first UGC data from the moderation platform.

9. The method of claim 8, further comprising:
determining a resource address and the moderation status of the first UGC data corresponding to the first UGC identifier in response to receiving the first UGC identifier from a second client;
obtaining the first UGC data by using the resource address in response to the moderation status meeting a predetermined condition; and
performing decompression and sending the first UGC data from the server to the second client.

10. The method of claim 9, further comprising:
rejecting access of the second client to the first UGC data in response to the moderation status not meeting the predetermined condition.

11. The method of claim 9, further comprising:
listening for a message that comes from the second client and that requests a specified avatar; and
sending an image link of the specified avatar from the server to the second client in response to receiving the message that requests the specified avatar.

12. The method of claim 9, wherein the resource address comprises a uniform resource locator (URL) of the first UGC data corresponding to the first UGC identifier.

13. The method of claim 12, wherein obtaining the first UGC data by using the resource address in response to the moderation status meeting a predetermined condition comprises:
receiving the URL of the first UGC data; and
downloading compressed first UGC data by using the URL.

14. A method for obtaining an effect, wherein the method is performed by a second client, and the method comprises:
requesting a first user-generated content (UGC) identifier corresponding to first UGC data from a server, wherein the first UGC data is generated from shooting by a first user on a first client based on an effect;
receiving the first UGC data from the server; and
rendering the effect of the first UGC data based on the first UGC data,
wherein the effect is configured to generate second UGC data shot by a second user on the second client, and
wherein the first UGC data and the second UGC data are configured to enable the second user to perform effect interaction on the second client.

15. The method of claim 14, further comprising:
receiving, by the second client, the first UGC identifier shared by the first user from the first client.

16. The method of claim 14, further comprising:
receiving, by the second client from the server, the first UGC identifier distributed by the server.

17. The method of claim 14, wherein sending the first UGC identifier corresponding to the first UGC data to the server comprises:
sending the first UGC identifier from the second client to the server in response to a user of the second client initiating a collaborative shooting.

18. The method of claim 17, wherein receiving the first UGC data from the server comprises:
receiving, by the second client, a resource address of the first UGC data from the server; and
receiving, by the second client, the first UGC data from the server based on the resource address.

19. The method of claim 14, further comprising:
sending, from the second client to the server, a message requesting a specified avatar in response to receiving a touch operation performed by the second user of the second client on an avatar control;
receiving, by the second client, an image link of the specified avatar from the server;
downloading the specified avatar based on the image link of the specified avatar; and
displaying the specified avatar on the second client in response to the specified avatar being successfully downloaded.

20. The method of claim 19, wherein the specified avatar comprises an avatar picture of the first user.
